(19) United States
(12) Patent Application Publication
(10) Pub. No.: US 2008/0074232 A1
(43) Pub. Date: Mar. 27, 2008

(54) Conductive positive temperature coefficient polymer composition and circuit protection device made therefrom

(75) Inventors: Jack Jih-Sang Chen, Taipei Hsien (TW); Chi-Hao Gu, Taipei Hsien (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Fuzetec Technology Co., Ltd., Hsin-Chuang City (TW)

(21) Appl. No.: 11/526,093

(22) Filed: Sep. 22, 2006

(51) Int. Cl. H01C 7/13

(52) U.S. Cl. 338/22 R

(57) ABSTRACT

A PTC circuit protection device has a resistivity at 20° C. of less than 10 ohm-cm and is made from a PTC polymer composition that contains: 40-70 vol % of a non-cross-linked polyvinylidene fluoride (PVDF) or a cross-linked polyvinylidene fluoride formed by cross-linking the non-cross-linked polyvinylidene fluoride by irradiation to a dosage less than 8 Mrads; and 30-60 vol % of a particulate conductive filler. The non-cross-linked polyvinylidene fluoride has a melting flow rate (MFR) of less than 120 g/10 min.

### BACKGROUND OF THE INVENTION

1. Field of the Invention

This invention relates to a positive temperature coefficient (PTC) polymer composition, more particularly to a PTC polymer composition containing non-cross-linked polyvinylidene fluoride or cross-linked polyvinylidene fluoride formed by irradiation to a dosage of less than 8 Mrad. This invention also relates to a circuit protection device made from the PTC polymer composition.

2. Description of the Related Art

It is known that conductive positive temperature coefficient (PTC) elements made from conductive polymer compositions are required to be cross-linked in order to avoid the undesired effect of negative temperature coefficient from taking place during operation. For instance, in order to prevent the PTC elements from being burned or damaged, polyolefin based PTC composition is normally cross-linked by irradiation to a dosage at least 10 Mrads, but no more than 150 Mrads, preferably from 25 Mrads to 125 Mrads, more preferably from 50 Mrads to 100 Mrads, and most preferably from 60 Mrads to 80 Mrads. (Reference to U.S. Pat. Nos. 5,378,407 and 6,512,446).

U.S. Pat. No. 5,093,898 discloses a conductive polymer composition having a resistivity at 20° C. of less than 10 ohm-cm. The conductive polymer composition contains polyvinylidene fluoride having a head-to-head content of less than 4.5%, and a particulate conductive filler dispersed in the polyvinylidene fluoride. The conductive polymer is irradiated to a dosage of 10 Mrads for making PTC elements. The polyvinylidene fluoride employed in the aforesaid patent has a trade name, Kynar, has a peak melting point of about 165° C., and is made by suspension polymerization which leads to a lower head-to-head content as compared to that made by emulsion polymerization.

U.S. Pat. No. 5,451,919 discloses a conductive polymer composition having a resistivity at 20° C. of less than 10 ohm-cm. The conductive polymer composition contains at least 50 vol % of polyvinylidene fluoride and 1-20 vol % of a second crystalline fluorinated polymer. The conductive polymer is irradiated to a dosage of 10 Mrads for making PTC elements. The polyvinylidene fluoride employed in the aforesaid patent has a trade name, Kynar.

However, the conventional conductive polymers disclosed in the aforesaid patents, which contain PVDF irradiated to a dosage of 10 Mrads, have a relatively poor electrical resistance stability.

### SUMMARY OF THE INVENTION

Therefore, the object of the present invention is to provide a PTC circuit protection device including a PTC element having a PTC polymer composition that can overcome the aforesaid drawback of the prior art.

According to one aspect of this invention, there is provided a PTC polymer composition that comprises non-cross-linked polyvinylidene fluoride having a melting flow rate of less than 120 g/10 min, and a particulate conductive filler.

According to another aspect of this invention, there is provided a conductive polymer composition that comprises: cross-linked polyvinylidene fluoride formed by cross-linking a non-cross-linked polyvinylidene fluoride by irradiation to a dosage less than 8 Mrads; and a particulate conductive filler. The non-cross-linked polyvinylidene fluoride has a melting flow rate of less than 120 g/10 min.

### BRIEF DESCRIPTION OF THE DRAWING

Other features and advantages of the present invention will become apparent in the following detailed description of the preferred embodiments of this invention, with reference to the accompanying drawing, in which:

FIG. 1 is a plot of the electrical resistance of the PTC element versus the irradiating dosage for different PTC polymer compositions having corresponding formulation nos. 1, 2, 10, 11, 12, and 13.

### DETAILED DESCRIPTION OF THE PREFERRED EMBODIMENTS

The PTC element of this invention, which is particularly useful in the manufacture of a PTC circuit protection device having a resistivity at 20° C. of less than 10 ohm-cm, has a PTC polymer composition comprising: 40-70 vol % of a non-cross-linked polyvinylidene fluoride (PVDF) or a cross-linked polyvinylidene fluoride formed by cross-linking the non-cross-linked polyvinylidene fluoride by irradiation to a dosage less than 8 Mrads; and 30-60 vol % of a particulate conductive filler. The non-cross-linked polyvinylidene fluoride has a melting flow rate (MFR) of less than 120 g/10 min.

Preferably, the cross-linked polyvinylidene fluoride is formed by cross-linking the non-cross-linked polyvinylidene fluoride by irradiating it to a dosage less than 4 Mrads.

Preferably, the non-cross-linked polyvinylidene fluoride has a melting flow rate ranging from 0.5-30 grams per 10 minutes, and a melting point ranging from 140 to 180° C.

The particulate conductive filler is preferably made from a conductive material selected from the group consisting of metal particles and particulate carbon black.

The merits of the PTC polymer composition of this invention will become apparent with reference to the following Examples.

### EXAMPLES 1-29 AND COMPARATIVE EXAMPLES 1-41

PTC elements of Examples 1-29 and Comparative Examples 1-41 were prepared in a conventional manner that involved compounding, compress molding, laminating with nickel plated copper foils, and compressing steps, but differ from each other in the PTC polymer composition and in the irradiating dosage for the polyvinylidene fluoride of the polymer composition. The PTC polymer compositions of the Examples 1-29 and the Comparative Examples 1-41 are represented by corresponding formulation numbers shown in Table 1.

TABLE 1

| Formulation | Polymer 1 | | Polymer 2 | | Conductive Filler | |
|---|---|---|---|---|---|---|
| no. | Type | Vol % | Type | Vol % | Type | Vol % |
| F1 | PVDF* | 58.3% | none | | Carbon Black | 41.7% |
| F2 | PVDF* | 62.2% | none | | Carbon Black | 37.8% |
| F3 | PVDF* | 57.3% | ETFE | 5.0% | Carbon Black | 37.7% |
| F4 | PVDF* | 52.2% | ETFE | 10.1% | Carbon Black | 37.7% |
| F5 | HDPE | 56.8% | PVDF* | 3.7% | Carbon Black | 39.5% |
| F6 | HDPE | 52.7% | PVDF* | 3.8% | Carbon Black | 43.6% |
| F7 | HDPE | 28.9% | Grafted-PE | 29% | Carbon Black | 42.2% |
| F8 | HDPE | 28.9% | Grafted-PE | 29% | Carbon Black | 42.2% |
| F9 | PVDF** | 67.2% | none | | Carbon Black | 32.8% |
| F10 | PVDF*** | 67.2% | none | | Carbon Black | 32.8% |
| F11 | PVDF**** | 67.2% | none | | Carbon Black | 32.8% |
| F12 | PVDF* | 50.0% | none | | Carbon Black | 50.0% |
| F13 | PVDF* | 55.0% | none | | Carbon Black | 45.0% |

PVDF*= Kynar 761 (Melting Point is about 170° C., MFR is about 0.5 g/10 min under 230° C. and load 5 kg condition, from Arkema).
PVDF**= Solef 1006 (Melting Point is about 175° C., MFR is about 120 g/10 min under 230° C. and load 5 kg condition, from Solvay Solexis)
PVDF***= Solef 6008(Melting Point is about 174° C., MFR is about 24 g/10 min under 230° C. and load 5 kg condition, from Solvay Solexis)
PVDF****= Solef 6010(Melting Point is about 173° C., MFR is about 6 g/10 min under 230° C. and load 5 kg condition, from Solvay Solexis)
ETFE= Tefzel ETFE HT 2181(Melting Point is about 260° C., MFR is about 6 g/10 min under ASTM D3159 condition, from Dupont)

### Electrical Resistance Stability Test

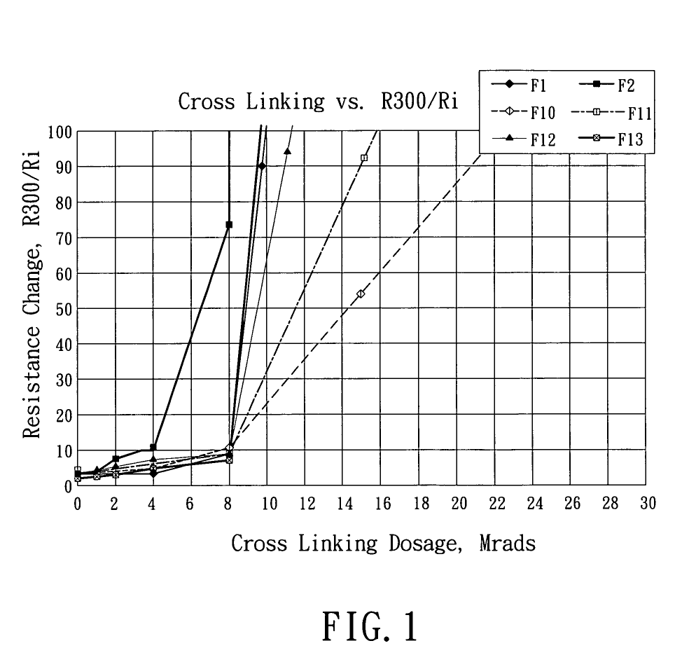

The PTC elements of Examples 1-29 and Comparative Examples 1-41 were tested in their electrical resistance stability. The tests included Trip Endurance Test, in which a current of 7.8 A was continuously applied to each test specimen at a voltage of 16V for 300 hours, and Cycle Test, in which a current of 7.8 A was applied to each test specimen at a voltage of 16V and at an interval of 1 minute on/1 minute off for 7200 cycles. The results of the electrical resistance stability test for Examples 1-29 and Comparative Examples 1-41 are shown in Table 2. As best shown in FIG. 1, the results show that the electrical resistance stability for formulation nos. F1, F2, F10, F11, F12 and F13 is greatly improved when the irradiating dosage for the PVDF (having an MFR less than 120 g/10 min) is less than 8 Mrads. In instances of higher irradiating dosage (above 8 Mrads) and lower irradiating dosage (below 8 Mrads), the PTC elements made from PVDF having an MFR of 120 g/10 min (formulation no. 9) were all burned out in the Trip Endurance Test, and the PTC elements made from PVDF having an MFR of 120 g/10 min were almost burned out in the Cycle Test (except for Comparative Examples 34 and 35 which have a higher irradiating dosage). In addition, the PTC elements made from formulation nos. 3 and 4 (which contains a major amount of PVDF having an MFR of 0.5 g/10 min, and a small amount of ETFE), and the PTC elements made from formulation nos. 5, 6, 7, and 8 (which contain a major amount of HDPE and a small amount of PVDF, or a mixture of HDPE and grafted PE) exhibit relatively poor electrical resistance stability. Moreover, for the PTC elements made from HDPE or the mixture of HDPE and grafted PE, the higher the irradiating dosage, the better will be the electrical resistance stability, which is in consistent with the teachings of the prior art.

TABLE 2

| | | | Trip | | | Cycle Test | | |
|---|---|---|---|---|---|---|---|---|
| | | X-linking | Endurance Test | | | (16 V/7.8 A, 1 min on/1 min | | |
| Exper. | Formulation | Dosage | (16 V/7.8 A, 300 hrs) | | | off, 7200Cycles) | | |
| No. | No | Mrad | Ri, ohm | R24/Ri | R300/Ri | Ri, ohm | R720c/Ri | R7200c/Ri |
| Exp. 1 | F1 | 0 | 0.0550 | 1.38 | 2.45 | 0.0511 | 3.11 | 2.03 |
| Exp. 2 | F1 | 1 | 0.0689 | 1.65 | 4.84 | 0.0649 | 3.48 | 3.28 |
| Exp. 3 | F1 | 2 | 0.0785 | 2.95 | 3.47 | 0.0638 | 4.34 | 4.60 |
| Exp. 4 | F1 | 4 | 0.0744 | 1.47 | 3.79 | 0.0730 | 4.88 | 3.95 |
| Exp. 5 | F1 | 8 | 0.0760 | 1.71 | 9.47 | 0.0691 | 4.70 | 8.41 |
| Comp. | F1 | 15 | 0.0713 | 55.34 | 330.54 | 0.0678 | 5.36 | 13.65 |
| Exp. 1 | | | | | | | | |
| Comp. | F1 | 30 | 0.0799 | 2039 | 22426 | 0.0699 | 5.95 | 111.24 |
| Exp. 2 | | | | | | | | |
| Exp. 6 | F2 | 0 | 0.0659 | 1.84 | 3.16 | 0.0580 | 3.50 | 3.30 |
| Exp. 7 | F2 | 1 | 0.0832 | 2.04 | 3.77 | 0.0624 | 2.84 | 4.33 |
| Exp. 8 | F2 | 2 | 0.0810 | 2.84 | 7.48 | 0.0657 | 3.31 | 3.75 |
| Exp. 9 | F2 | 4 | 0.0887 | 4.56 | 10.88 | 0.0743 | 1.75 | 1.98 |
| Exp. 10 | F2 | 8 | 0.1082 | 9.73 | 73.66 | 0.0987 | 1.60 | 2.70 |
| Comp. | F2 | 15 | 0.0923 | 135.36 | 1915.5 | 0.0939 | 2.30 | 41.14 |
| Exp. 3 | | | | | | | | |
| Comp. | F2 | 30 | 0.0993 | 1335.8 | 20156.27 | 0.0854 | 3.79 | 208.03 |
| Exp. 4 | | | | | | | | |
| Comp. | F3 | 0 | 0.0548 | Burned | xxxx | 0.0377 | Burned | xxxx |
| Exp. 5 | | | | | | | | |
| Comp. | F3 | 5 | 0.0432 | 15.82 | Burned | 0.0429 | 6.36 | Burned |
| Exp. 6 | | | | | | | | |
| Comp. | F3 | 15 | 0.0419 | 31.91 | 189.34 | 0.0395 | 2.52 | 18.47 |
| Exp. 7 | | | | | | | | |
| Comp. | F3 | 30 | 0.0352 | 16.53 | 63.45 | 0.0420 | 2.78 | 10.89 |
| Exp. 8 | | | | | | | | |
| Comp. | F4 | 0 | 0.0524 | Burned | xxxx | 0.0566 | Burned | xxxx |
| Exp. 9 | | | | | | | | |
| Comp. | F4 | 5 | 0.0482 | 58.54 | Burned | 0.0391 | 16.29 | Burned |
| Exp. 10 | | | | | | | | |
| Comp. | F4 | 15 | 0.0444 | 63.39 | 849.34 | 0.0428 | 6.21 | 54.38 |
| Exp. 11 | | | | | | | | |
| Comp. | F4 | 30 | 0.0416 | 49.31 | 239.41 | 0.0408 | 4.92 | 34.56 |
| Exp. 12 | | | | | | | | |
| Comp. | F5 | 0 | 0.0222 | Burned | xxxx | 0.0214 | Burned | xxxx |
| Exp. 13 | | | | | | | | |
| Comp. | F5 | 5 | 0.0243 | Burned | xxxx | 0.0238 | Burned | xxxx |
| Exp. 14 | | | | | | | | |
| Comp. | F5 | 15 | 0.0256 | 8.75 | Burned | 0.0243 | Burned | xxxx |
| Exp. 15 | | | | | | | | |
| Comp. | F5 | 30 | 0.0265 | 9.51 | 88.54 | 0.0254 | 6.89 | Burned |
| Exp. 16 | | | | | | | | |
| Comp. | F6 | 0 | 0.0180 | Burned | xxxx | 0.0176 | Burned | xxxx |
| Exp. 17 | | | | | | | | |
| Comp. | F6 | 5 | 0.0184 | Burned | xxxx | 0.0183 | Burned | xxxx |
| Exp. 18 | | | | | | | | |
| Comp. | F6 | 15 | 0.0192 | Burned | xxxx | 0.0184 | Burned | xxxx |
| Exp. 19 | | | | | | | | |
| Comp. | F6 | 30 | 0.0195 | Burned | xxxx | 0.0193 | Burned | xxxx |
| Exp. 20 | | | | | | | | |
| Comp. | F7 | 0 | 0.0732 | 15.54 | Burned | 0.0754 | Burned | xxxx |
| Exp. 21 | | | | | | | | |
| Comp. | F7 | 5 | 0.0741 | 10.32 | 30.34 | 0.0753 | 20.43 | Burned |
| Exp. 22 | | | | | | | | |
| Comp. | F7 | 15 | 0.0752 | 5.43 | 8.34 | 0.0793 | 3.42 | 10.32 |
| Exp. 23 | | | | | | | | |
| Comp. | F7 | 30 | 0.0761 | 4.95 | 6.53 | 0.0757 | 2.89 | 7.36 |
| Exp. 24 | | | | | | | | |
| Comp. | F8 | 0 | 0.0631 | Burned | xxxx | 0.0643 | Burned | xxxx |
| Exp. 25 | | | | | | | | |
| Comp. | F8 | 5 | 0.0642 | 12.34 | 50.34 | 0.0632 | 25.34 | Burned |
| Exp. 26 | | | | | | | | |
| Comp. | F8 | 15 | 0.0662 | 4.53 | 9.43 | 0.0649 | 5.95 | 8.32 |
| Exp. 27 | | | | | | | | |
| Comp. | F8 | 30 | 0.0673 | 4.23 | 8.86 | 0.0612 | 4.32 | 6.45 |
| Exp. 28 | | | | | | | | |
| Comp. | F9 | 0 | 0.0574 | Burned | xxxx | 0.0573 | Burned | xxxx |
| Exp. 29 | | | | | | | | |
| Comp. | F9 | 1 | 0.0583 | Burned | xxxx | 0.0587 | Burned | xxxx |
| Exp. 30 | | | | | | | | |
| Comp. | F9 | 2 | 0.0593 | Burned | xxxx | 0.0593 | Burned | xxxx |
| Exp. 31 | | | | | | | | |
| Comp. | F9 | 4 | 0.0599 | Burned | xxxx | 0.0603 | Burned | xxxx |
| Exp. 32 | | | | | | | | |
| Comp. | F9 | 8 | 0.0573 | Burned | xxxx | 0.0591 | Burned | xxxx |
| Exp. 33 | | | | | | | | |
| Comp. | F9 | 15 | 0.0559 | Burned | xxxx | 0.0598 | 0.34 | Burned |
| Exp. 34 | | | | | | | | |
| Comp. | F9 | 30 | 0.0568 | Burned | xxxx | 0.0584 | 2.34 | 1.22 |
| Exp. 35 | | | | | | | | |
| Exp. 11 | F10 | 0 | 0.0645 | 1.56 | 3.45 | 0.0643 | 1.78 | 3.23 |
| Exp. 12 | F10 | 1 | 0.0679 | 1.32 | 4.35 | 0.0664 | 2.14 | 4.53 |
| Exp. 13 | F10 | 2 | 0.0681 | 1.59 | 3.67 | 0.0631 | 2.57 | 4.69 |
| Exp. 14 | F10 | 4 | 0.0695 | 2.31 | 4.79 | 0.0683 | 3.24 | 5.31 |
| ExP. 15 | F10 | 8 | 0.0693 | 2.69 | 10.45 | 0.0626 | 3.58 | 9.76 |
| Comp. | F10 | 15 | 0.0711 | 1.24 | 53.64 | 0.0593 | 3.90 | 11.64 |
| Exp. 36 | | | | | | | | |
| Comp. | F10 | 30 | 0.0699 | 3.56 | 148.43 | 0.0619 | 5.69 | 93.23 |
| Exp. 37 | | | | | | | | |
| Exp. 16 | F11 | 0 | 0.0967 | 2.45 | 4.53 | 0.0953 | 2.02 | 2.78 |
| Exp. 17 | F11 | 1 | 0.0987 | 2.96 | 3.89 | 0.0963 | 2.98 | 3.22 |
| Exp. 18 | F11 | 2 | 0.1023 | 3.56 | 4.82 | 0.0925 | 3.58 | 3.62 |
| Exp. 19 | F11 | 4 | 0.1045 | 5.63 | 5.78 | 0.0954 | 3.67 | 4.61 |
| Exp. 20 | F11 | 8 | 0.1094 | 6.34 | 8.51 | 0.0957 | 3.21 | 6.78 |
| Comp. | F11 | 15 | 0.1180 | 13.67 | 92.12 | 0.0910 | 4.65 | 34.34 |
| Exp. 38 | | | | | | | | |
| Comp. | F11 | 30 | 0.1032 | 38.34 | 225.63 | 0.0942 | 8.53 | 107.34 |
| Exp. 39 | | | | | | | | |
| Exp. 21 | F12 | 0 | 0.0358 | 1.12 | 1.98 | 0.0373 | 2.75 | 3.79 |
| Exp. 22 | F12 | 1 | 0.0475 | 1.34 | 3.92 | 0.0454 | 2.76 | 4.60 |
| Exp. 23 | F12 | 2 | 0.0502 | 2.39 | 4.81 | 0.0402 | 4.25 | 5.85 |
| Exp. 24 | F12 | 4 | 0.0484 | 4.76 | 7.37 | 0.0533 | 4.69 | 8.64 |
| Exp. 25 | F12 | 8 | 0.0570 | 5.82 | 8.54 | 0.0451 | 5.58 | 9.99 |
| Comp. | F12 | 15 | 0.0520 | 39.98 | 98.82 | 0.0468 | 6.43 | 16.37 |
| Exp. 39 | | | | | | | | |
| Comp. | F12 | 30 | 0.0559 | 1651.59 | 8165.06 | 0.0477 | 7.20 | 134.60 |
| Exp. 40 | | | | | | | | |
| Exp. 25 | F13 | 0 | 0.0440 | 1.24 | 2.21 | 0.0424 | 2.92 | 3.91 |
| Exp. 26 | F13 | 1 | 0.0572 | 1.49 | 2.36 | 0.0506 | 3.10 | 4.92 |
| Exp. 27 | F13 | 2 | 0.0612 | 2.66 | 3.12 | 0.0530 | 4.30 | 5.55 |
| Exp. 28 | F13 | 4 | 0.0610 | 2.65 | 4.82 | 0.0606 | 4.78 | 8.87 |
| Exp. 29 | F13 | 8 | 0.0638 | 3.25 | 6.99 | 0.0574 | 5.12 | 9.67 |
| Comp. | F13 | 15 | 0.0556 | 47.04 | 80.96 | 0.0563 | 5.87 | 19.95 |
| Exp. 41 | | | | | | | | |

Accordingly, the applicants have discovered that PTC polymer compositions containing non-cross-linked PVDF or low dosage irradiated cross-linked PVDF, which have an MFR of less than 120 g/10 min, exhibit an excellent electrical resistance stability.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A positive temperature coefficient (PTC) polymer composition comprising:
non-cross-linked polyvinylidene fluoride having a melting flow rate of less than 120 g/10 min; and
a particulate conductive filler.

2. The PTC polymer composition of claim 1, wherein said PTC polymer composition contains 40-70 vol % of said non-cross-linked polyvinylidene fluoride and 30-60 vol % of said conductive filler.

3. The PTC polymer composition of claim 1, wherein said non-cross-linked polyvinylidene fluoride has a melting flow rate ranging from 0.5-30 grams per 10 minutes.

4. The PTC polymer composition of claim 3, wherein said non-cross-linked polyvinylidene fluoride has a melting point ranging from 140 to 180° C.

5. The PTC polymer composition of claim 1, wherein said conductive filler is carbon black.

6. A positive temperature coefficient (PTC) polymer composition comprising:
cross-linked polyvinylidene fluoride formed by cross-linking a non-cross-linked polyvinylidene fluoride by irradiation to a dosage less than 8 Mrads; and
a particulate conductive filler;
wherein said non-cross-linked polyvinylidene fluoride has a melting flow rate of less than 120 g/10 min.

7. The PTC polymer composition of claim 6, wherein said PTC polymer composition contains 40-70 vol % of said cross-linked polyvinylidene fluoride and 30-60 vol % of said conductive filler.

8. The PTC polymer composition of claim 6, wherein said dosage is less than 4 Mrads.

9. The PTC polymer composition of claim 6, wherein said non-cross-linked polyvinylidene fluoride has a melting flow rate ranging from 0.5-30 grams per 10 minutes.

10. The PTC polymer composition of claim 9, wherein said non-cross-linked polyvinylidene fluoride has a melting point ranging from 140 to 180° C.

11. The PTC polymer composition of claim 6, wherein said conductive filler is carbon black.

12. A circuit protection device having a resistivity at 20° C. of less than 10 ohm-cm, said circuit protection device comprising:
a conductive polymer element exhibiting positive temperature coefficient and having a PTC polymer composition containing non-cross-linked polyvinylidene fluoride having a melting flow rate of less than 120 g/10 min, and a particulate conductive filler; and
two electrodes connected to said conductive polymer element and adapted to receive electrical power so as to cause current to flow through said conductive polymer element.

13. The circuit protection device of claim 12, wherein said PTC polymer composition contains 40-70 vol % of said non-cross-linked polyvinylidene fluoride and 30-60 vol % of said conductive filler.

14. The circuit protection device of claim 12, wherein said non-cross-linked polyvinylidene fluoride has a melting flow rate ranging from 0.5-30 grams per 10 minutes.

15. The circuit protection device of claim 14, wherein said non-cross-linked polyvinylidene fluoride has a melting point ranging from 140 to 180° C.

16. The circuit protection device of claim 12, wherein said conductive filler is carbon black.

17. A circuit protection device having a resistivity at 20° C. of less than 10 ohm-cm, said circuit protection device comprising:
a conductive polymer element exhibiting positive temperature coefficient and having a PTC polymer composition containing cross-linked polyvinylidene fluoride and a particulate conductive filler, said cross-linked polyvinylidene fluoride being formed by cross-linking a non-cross-linked polyvinylidene fluoride by irradiation to a dosage less than 8 Mrads, said non-cross-linked polyvinylidene fluoride having a melting flow rate of less than 120 g/10 min; and
two electrodes connected to said conductive polymer element and adapted to receive electrical power so as to cause current to flow through said conductive polymer element.

18. The circuit protection device of claim 17, wherein said PTC polymer composition contains 40-70 vol % of said cross-linked polyvinylidene fluoride and 30-60 vol % of said conductive filler.

19. The circuit protection device of claim 17, wherein said dosage is less than 4 Mrads.

20. The circuit protection device of claim 17, wherein said non-cross-linked polyvinylidene fluoride has a melting flow rate ranging from 0.5-30 grams per 10 minutes.

21. The circuit protection device of claim 20, wherein said non-cross-linked polyvinylidene fluoride has a melting point ranging from 140 to 180° C.

22. The circuit protection device of claim 17, wherein said conductive filler is carbon black.
